(19) United States
(12) Patent Application Publication
(10) Pub. No.: US 2016/0076351 A1
(43) Pub. Date: Mar. 17, 2016

(54) Method For Hydraulic Fracking Of An Underground Formation

(71) Applicant: WINTERSHALL HOLDING GMBH, Kassel (DE)

(72) Inventor: Vladimir Stehle, Kassel (DE)

(21) Appl. No.: 14/783,680

(22) PCT Filed: Apr. 9, 2014
(86) PCT No.: PCT/EP2014/057179

§ 371 Date: Oct. 9, 2015

(30) Foreign Application Priority Data
Apr. 10, 2013 (EP) 13163103.8

(51) Int. Cl. E21B 43/267; C09K 8/80

(52) U.S. Cl. CPC E21B 43/267; C09K 8/80

(57) ABSTRACT

A method for hydraulic fracking of an underground formation comprises: a)introducing a fracking fluid (FF) through at least one well into an underground formation at a pressure greater than the minimum in-situ rock stress for formation of fracks (FR) in the underground formation, the fracking fluid (FF) comprising water and aluminum, and b)waiting for a rest phase in which an exothermic oxidation reaction between aluminum and the water from the fracking fluid (FF) takes place.

The present invention relates to a method for hydraulic fracking of an underground formation and to a fracking fluid (FF) which can be used in the method according to the invention.

In the production of hydrocarbons from underground formations, at least one well is typically first sunk (driven) into the underground formation. In order to increase the flow of fluids (for example natural gas and/or mineral oil) into and/or out of the formation, it is customary to hydraulically fracture at least some sections of the well. This method is also referred to as “hydraulic fracturing” or “hydraulic fracking”. “Hydraulic fracking” (hydraulically fracturing/breaking up an underground formation) is understood to mean the occurrence of a fracture event in the underground formation in the area surrounding the well as a result of the hydraulic action of a liquid pressure or gas pressure on the area surrounding the well.

In the known methods for hydraulic fracturing, a work string is typically sunk into the well. The section of the well which is to be hydraulically fractured is normally perforated using known technologies, for example by what is called gun perforation. This forms orifices in the casing of the well and short channels in the surrounding rock mass. The section of the well which is to be hydraulically fractured is generally isolated from the adjacent well sections which are not to be hydraulically fractured. For this purpose, seals (packers) are used.

Subsequently, a fracking fluid (for example a water-based gel with or without proppants) is pumped downward through the work string into the section of the well isolated by packers, which is to be hydraulically fractured. Once there, the fracking fluid passes through the perforation holes into the rock stratum to be fractured, which surrounds the well. The fracking fluid is pumped into the rock stratum to be fractured at a pressure sufficient to divide or to “fracture” this rock stratum of the formation.

This widens existing natural fissures and cracks which have been formed in the course of evolution of the geological formation and in the event of subsequent tectonic movements, and produces new cracks, crevices and fissures, also called fracks or hydrofracks. The alignment of the hydrofracks thus hydraulically induced depends particularly on the state of rock stress which exists. The pressure level with which the fracking fluid is pumped into the formation depends on the properties of the rocks and the rock pressure. The aim is to increase the gas and liquid perviosity of the rock stratum, i.e. to improve hydrodynamic communication, such that economically viable extraction of resources (e.g. mineral oil and natural gas) is enabled. The method is also employed for release of rock pressure or for development of underground geothermal deposits.

Water-based hydraulic fracking has become ever more important in the last few years. This involves using fracking fluids comprising water, gel formers and optionally crosslinkers. The use of crosslinkers leads to spontaneous gel formation within a few minutes. The addition of aldehydes such as glyoxal can delay gel formation if this is desirable. In addition, the fracking fluid may comprise proppant material such as sand. The proppant material should remain in the cracks formed in the course of fracking, in order to keep them open. It is possible to add further additives to the fracking fluid, for example clay stabilizers, biocides or gel stabilizers.

A particular challenge is gas production from virtually impervious geological formations (tight gas reservoirs, shale gas reservoirs). Hydraulic stimulation techniques (fracking) in conjunction with appropriate drilling techniques should enable the economically necessary production rates from tight gas deposits and shale gas deposits and hence open up future supply reserves. In tight gas deposits, the underground formation generally has a relatively high clay content. In the course of hydraulic fracking, the fracking water is introduced deep into the formation. As a result, the deposit is subject to severe water contamination. The water leads to swelling of the clay rocks in the underground formation. This swelling reduces permeability. In this context, economic viability is crucially dependent on the success of the hydraulic fracking.

Frequently, however, the results of hydraulic fracking remain well below the values predicted. Therefore, the global proportion of natural gas production from “tight” reservoir rocks is currently still very low. “Tight gas” refers to natural gas present in very compact, virtually impervious rock. In order to produce natural gas from tight gas fields, the horizontal drilling technique is combined with hydraulic fracking.

In the hydraulic fracking methods described in the prior art, many wells after fracking behave as if the cracks and fissure structures formed are much shorter than those actually present. This means that hydrodynamic communication is poorer than would have been expected on the basis of the number and length of the cracks and fissure structures formed. In the course of hydraulic fracking, the cracks and fissure structures formed are filled with the fracking fluid injected. The fracking fluid thus blocks the escape of fluids such as mineral oil or natural gas from the formation through the cracks and fissure structures in the direction of the well. For this reason, the fracking fluid has to be removed again from the cracks and fissures formed after hydraulic fracking.

The most difficult part of the fracking fluid to remove is the part which is in the tip of the fissure structure, i.e. in the section of the fissure structure furthest removed from the well. As a result of the fracking fluid remaining in the fissure structure, there is a reduction in the amount of hydrocarbons obtained, since the fracking fluid, as described above, acts as a barrier to the movement of hydrocarbons out of the formation through the fissure structure into the well. This length of the fissure structure, reduced in this way, is also referred to as “effective fissure structure length”. The effective fissure structure length is an important variable which limits hydrocarbon production from a given well. This is especially true for gas deposits with low perviosity.

In order to achieve an increase in the effective fissure structure length such that it approaches the actual fissure structure length, efforts are generally made to remove as much of the remaining fracking fluid as possible from the fissure structure.

The deliberate removal of fracking fluid from the fissure structure is known as “rehabilitation”. This expression relates to the recovery of the fracking fluid after the proppant has been deposited in the fissure structure. A customary method for rehabilitation of a fissure structure comprises simply “draining” or pumping out the fracking fluid. For this purpose, the fracking fluid in the tip of the fissure structure has to pass through the entire length of the fissure structure (as far as the well). Simply pumping out the fracking fluid generally removes it only incompletely from the fissure structures and cracks, such that the effective fissure structure length is generally much shorter than the actual fissure structure length.

In the methods for hydraulic fracking described in the prior art, the fracking fluids used are generally water-based gels. These can be removed from the fissure structures only with difficulty because of the high viscosity. In order to reduce the viscosity of the water-based gels and simplify the rehabilitation, what are called gel breakers are used in order to achieve a decrease in the viscosity of the fracking fluid used. The gel breakers used are, for example, strong oxidizing agents such as ammonium persulfate. After the actual hydraulic fracking, solutions of the oxidizing agents are subsequently pumped into the fissure structures for this purpose. The oxidizing agent chemically degrades the gel formers present in the fracking fluid, which results in a decrease in the viscosity of the fracking fluid.

In order to remove as much as possible of the fracking fluid and to rehabilitate the hydraulically induced fissure structures after the performance of hydraulic fracking methods, the prior art describes numerous, very complex methods.

DE 2 933 037 A1 describes a hydraulic fracking method suitable for the fracking of gas-bearing sandstone formations. The method comprises several stages in which fracking fluids which conduct a fine proppant material sand having a size in the range from 0.25 to 0.105 mm are used in a sand/fluid mixing ratio of 0.48 kg/l. Every stage involving proppant material sand is followed immediately by a corresponding stage in which a fracking fluid without proppant material sand is used. Immediately after the last stage involving proppant material sand and the corresponding stage without proppant material sand, in a final stage, a fracking fluid comprising a proppant material sand having a size in the range from 0.84 to 0.42 mm is injected, followed by a purge of the well string with fracking fluid. The fracking fluid comprises up to 70% by volume of alcohol, in order to reduce the water volume of the fracking fluid, which reacts adversely with water-sensitive clays within the formation. In addition, up to 20% by volume of liquefied carbon dioxide is combined with the fracking water/alcohol mixture, in order to further reduce the water volume.

The method according to DE 2 933 037 A1 is very costly because of the multitude of different stages and because of the alcohol used as a solvent and the liquid carbon dioxide. Moreover, the fracking fluid cannot be fully removed by the method according to DE 2 933 037 A1.

A further method for hydraulic fracking is described in DE 699 30 538 T2. In this method, a fracking fluid is introduced sequentially into a well. The fracking fluid in the individual sequences is selected such that the fracking fluid close to the fissure structure tip has a lower viscosity and/or a lower density than the fracking fluid close to the well. This viscosity and/or density gradient is supposed to facilitate the removal of the fracking fluid from the fissure structure tip.

The sequential method according to DE 699 30 538 T2 is likewise very costly and inconvenient. With this method too, the removal of the fracking fluid from the tip of the fissure structure formed is not reliably assured.

Moreover, RU 2 387 821 discloses a method in which fracking of the deposit is accomplished using a fracking fluid in which proppant material and granulated magnesium are suspended. Subsequently, hydrochloric acid is compressed into the fracks formed. The hydrochloric acid reacts with the granulated magnesium to form hydrogen and heat according to the following reaction equation: 2HCl+Mg=MgCl₂+H₂+(Q, kcal). This method has the disadvantage that, after the injection of the fracking fluid, the injection of a further solution is necessary in order to initiate the reaction between magnesium and hydrochloric acid. The mixing of the fracking fluid with the subsequent injected hydrochloric acid, especially in the tip region of the fracks formed, is additionally not always reliably assured.

The methods described in the prior art for hydraulic fracking of underground formations are very costly and inconvenient. The known methods usually do not ensure reliable removal of as much as possible of the fracking fluid used for hydraulic fracking from the fissure structures formed. The methods described in the prior art usually achieve only effective fissure structure lengths much shorter than the actual fissure structure lengths.

There was therefore a need for further methods for hydraulic fracking of geological formations, which have the disadvantages of the methods described in the prior art only to reduced degrees, if at all. More particularly, it is an object of the present invention to provide a method for hydraulic fracking of rock formations, in which a greater effective fissure structure length is achieved and hydrodynamic communication between the underground formation and the well is improved. The method is to be simple, reliable, environmentally friendly and inexpensive to perform.

This object is achieved by the method according to the invention for hydraulic fracking of an underground formation into which at least one well has been sunk, comprising the method steps of
a) introducing a fracking fluid (FF) through the at least one well into the underground formation at a pressure greater than the minimum in-situ rock stress for formation of fracks (FR) in the underground formation, the fracking fluid (FF) comprising water and aluminum, and
b) waiting for a rest phase in which an exothermic oxidation reaction between aluminum and the water from the fracking fluid (FF) takes place.

The above-described actual fissure structure length is also referred to hereinafter as actual frack length (aFL). The above-described effective fissure structure length is also referred to hereinafter as effective frack length (eFL).

The method according to the invention enables the effective improvement of the hydrodynamic communication between an underground formation and a well. The fracks (FR) obtained by the method according to the invention have an effective frack length (eFL) corresponding approximately to the actual frack length (aFL). As explained in detail hereinafter, this is achieved by at least partial removal, in method step b), of the fracking fluid (FF) introduced in method step a), which is used in the formation of the fracks (FR), from the fracks (FR) formed. This is attributable to at least partial vaporization or consumption of the water present in the fracking fluid (FF) in the exothermic oxidation reaction with aluminum which takes place in method step b).

As a result of this, the costly and inconvenient rehabilitation, described in the prior art, of the fracks (FR) formed in the hydraulic fracking operation is not required, or at least the cost and inconvenience associated with rehabilitation is significantly reduced.

In the method according to the invention, in method step b), the water present in the fracking fluid (FF) is consumed or vaporized. As a result, the fracks (FR) formed are virtually “dried out”. As a result, the swelling of the clay rocks in the underground formation is very substantially suppressed and any associated decrease in the permeability is prevented or at least reduced.

In method step b) of the method according to the invention, the fracking fluid (FF) virtually removes itself, and so the inconvenient and costly rehabilitation steps described in the prior art need not necessarily be performed in the method according to the invention.

### Underground Formation

The method according to the invention can be used for development of shale gas deposits, of tight gas deposits, of shale oil deposits, of oil deposits in impervious reservoirs, of bitumen and heavy oil deposits using “in situ combustion”, gas extraction from coal formations, underground gasification of coal seams, underground leaching in metal extraction, release of rock pressure and modification of stress fields in geological formations, water extraction from underground deposits, and for development of underground geothermal deposits.

The method according to the invention can be used for hydraulic fracking of all known underground formations into which at least one well has been sunk. Preference is given to using the method according to the invention in underground deposits bearing one or more raw materials. Suitable raw materials are those described above, for example natural gas, mineral oil, coal or water. The terms “underground formation” and “underground deposit” are used synonymously hereinafter.

Preferably, however, the method according to the invention is used for hydraulic fracking of underground formations comprising hydrocarbons such as mineral oil and/or natural gas as raw materials. Preferred underground formations are thus hydrocarbon deposits which bear mineral oil and/or natural gas, and into which at least one well has been sunk. Particular preference is given to natural gas deposits. The present invention also provides a method in which the underground formation is a natural gas deposit having a deposit permeability of less than 10 millidarcies. The method according to the invention can be employed either in injection wells or in production wells. The form and configuration of the well is not crucial to the method according to the invention. The method according to the invention for hydraulic fracking can be employed in vertical, horizontal, and in quasi-vertical or quasi-horizontal wells. In addition, the method according to the invention can be employed in directional wells comprising a vertical or quasi-vertical section and a horizontal or quasi-horizontal section.

The temperature T_{D} of the underground deposit (underground formation) which is hydraulically fracked by the method according to the invention is typically in the range from greater than 65 to 200° C., preferably in the range from 70 to 150° C., more preferably in the range from 80 to 150° C. and especially in the range from 90° C. to 150° C. The temperature T_{D} is also referred to as the deposit temperature T_{D}.

The present invention thus also provides a method in which the underground deposit has a deposit temperature (T_{D}) in the range from greater than 65 to 200° C., preferably in the range from 70 to 150° C., more preferably in the range from 80 to 150° C. and especially in the range from 90 to 150° C.

The sinking of at least one well into the underground formation is known per se. The sinking of wells can be effected by conventional methods known to those skilled in the art and is described, for example, in EP 09 523 00.

Fracking fluid (FF)

The fracking fluid (FF) comprises aluminum and water.

The aluminum is preferably used in particulate form. The particle size of the aluminum is generally 20 nm to 1000 μm, preferably 20 nm to 500 μm and more preferably 50 nm to 50 μm. The particle size of the aluminum may thus be in the p-meter range (μ-aluminum) and/or in the n-meter range (n-aluminum). n-Aluminum is understood to mean aluminum having a particle size in the range from 50 to less than 1000 nm. μ-Aluminum is understood to mean aluminum having a particle size in the range from 1 to less than 1000 μm.

The present invention thus also provides a method wherein the fracking fluid (FF) comprises a mixture of aluminum particles having a particle size in the range from 50 to less than 1000 nm (n-aluminum) and aluminum particles having a particle size in the range from 1 to less than 1000 μm.

In one embodiment, the fracking fluid (FF) comprises a mixture of n-aluminum and μ-aluminum. Preferably, the ratio of n-aluminum to p-aluminum in the fracking fluid (FF) is in the range from 1:10 to 10:1.

The invention also relates to a method in which the n-aluminum particles and the μ-aluminum particles are larger than the rock pores.

The invention further relates to a method in which at least some of the aluminum particles are smaller than the rock pores. In this case, it is preferably the n-aluminum particles that are smaller than the rock pores.

Rock pores are understood in the present context to mean the pores of the rock which surrounds the fracks (FR) formed in method step a).

If both the n-aluminum particles and the p-aluminum particles are larger than the rock pores, the aluminum particles accumulate in the fracks (FR) formed in method step a).

The rock pores then function effectively as filters. The water present in the fracking fluid (FF) penetrates into the rock pores, and the aluminum particles are retained in the fracks (FR).

In a further embodiment, only the p-aluminum particles are larger than the rock pores. In this embodiment, only the p-aluminum particles accumulate in the fracks (FR). The n-aluminum particles penetrate into the rock pores together with the water.

The combination of μ-aluminum and n-aluminum has the following advantages:
n-Aluminum reacts more readily and quickly with the water than μ-aluminum. Thus, n-aluminum plays the role of an “activator” for the μ-aluminum. The n-aluminum particles are the first to react with the water and ensure the rise in the temperature. As a result, the μ-aluminum particles are also included in the reaction.
Some of the n-aluminum particles can penetrate into the rock pores and, as a result of the thermal shock and steam formation in method step b), enlarge the rock pores and form microcracks.

The industrial manufacture of the aluminum particles is known and can be effected, for example, by means of vibratory mills or roll mills. The aluminum is preferably suspended in particulate form in the fracking fluid (FF).

Aluminum is understood in the present context to mean aluminum itself and aluminum alloys which may comprise up to 10% by weight of further metals as alloy constituents.

Aluminum or aluminum particles used according to the invention are usually prepared in a grinding process. Vibrating mills or roller mills can be applied as grinding unit. In general, aluminum particles form a passivation layer on their surface in the presence of oxygen.

The aluminum particles used may generally have a passivation layer comprising oxides and/or hydroxides of the corresponding metal, i.e. aluminum oxide and/or aluminum hydroxide in the case of aluminum, which is used with preference.

This passivation layer slows the oxidation reaction of the aluminum with water. The passivation layer is gradually dissolved in water at the temperatures of the underground formation (underground deposit). After the dissolution of the passivation layer, the actual oxidation reaction of the metal with water sets in.

In the case of μ-aluminum, the passivation layer in the case of aluminum particles having a particle size in the range from 80 to 120 μm, for example, is 14 to 20 μm in thickness. In the case of n-aluminum, the passivation layer in the case of aluminum particles having a particle size in the range from 80 to 120 nm, for example, is 2 to 7 nm in thickness.

In one embodiment, the aluminum or aluminum particles used in accordance with the invention, aside from the passivation layer, do not have any further coating or shell selected from the group consisting of hard wax, polypropylene, polyethylene, nylon, vinyl, Teflon, glass, plastic, thermoplastic, rubber, lacquer, paint, cellulose, lignin, starch, polymers, conductive polymers, metals (other than aluminum) and electrically conductive materials.

In a preferred embodiment, the aluminum or aluminum particles, aside from a passivation layer, do not comprise any further coating or shell.

The present invention thus also provides a method in which the aluminum present in the fracking fluid (FF) comprises a passivation layer consisting essentially of aluminum oxide and aluminum hydroxide, and does not comprise any further coating or shell beyond that.

Preference is thus given to uncoated aluminum or aluminum particles.

The present invention thus also provides a method in which the aluminum present in the fracking fluid (FF) is uncoated.

“Uncoated” is understood in accordance with the invention to mean that the aluminum or aluminum particles, aside from the passivation layer, do not comprise any further coating.

The fracking fluid (FF) generally comprises water and aluminum in a mass ratio M_{aq}:M_{Al} of >25, where M_{aq} indicates the mass of the water present in the fracking fluid (FF) in kg and M_{Al} the mass of the aluminum present in the fracking fluid (FF) in kg. Preferably, the mass ratio M_{aq}:M_{Al} is in the range from >25 to 200, more preferably in the range from >25 to 100.

The fracking fluid (FF) may additionally comprise a proppant (PP).

Suitable proppants (PP) are known to those skilled in the art. Suitable proppants (PP) are, for example, particulate ceramic materials such as sand, bauxite or glass beads. The particle size of the proppant is guided by the geometry of the fracks (FR) formed, which are to be propped. Suitable particle sizes are generally in the range from 0.15 mm to 3.0 mm.

For every deposit, the particle size and other parameters of the proppant (PP) are optimized. In general, proppants (PP) with relatively small particle size are selected for natural gas deposits, and proppants (PP) with greater particle size for mineral oil deposits.

The perviosity/permeability of the proppant-filled fracks should be 10³ to 10⁸ greater than the permeability of the deposit; this ensures optimal conditions for the gas or oil production.

The proppant (PP) serves to hold open the fracks (FR) formed in the course of hydraulic fracking. This means that the proppant (PP) prevents the fracks (FR) from closing again when method step a) has ended and the hydraulic pressure built up by the fracking fluid (FF) from decreasing again.

For this purpose, the proppant (PP) has to be introduced into the fracks (FR) formed in method step a). The proppant (PP) is therefore generally likewise suspended in the fracking fluid (FF).

The water present in the fracking fluid (FF) serves as a carrier or transport medium, in order to transport the proppant (PP) and the aluminum particles into the fracks. The carrier or transport medium is also referred to hereinafter as aqueous carrier fluid (AC).

The aqueous carrier fluid (AC) used may be water itself. It is also possible to use, as the aqueous carrier fluid (AC), a mixture of water and one or more organic solvents. Suitable organic solvents are, for example, glycerol, methanol or ethanol.

The aqueous carrier fluid (AC) serves here as a transport medium, with the aid of which the proppant (PP) and the aluminum are transported into the fracks (FR).

The proppant (PP) is present in the fracking fluid (FF) generally in amounts of 1 to 65% by weight, preferably in amounts of 10 to 40% by weight and more preferably in amounts of 25 to 35% by weight, based on the total weight of the fracking fluid (FF). The amount of the proppant (PP) used depends on the deposit properties.

The water used may be pure water, seawater, partly demineralized seawater or formation water. Formation water in the present context is understood to mean water originally present in the deposit, and water which has been introduced into the deposit by process steps of secondary and tertiary production, for example what is called flood water.

In addition, the fracking fluid (FF) may comprise urea. In this case, the urea is preferably present dissolved in the aqueous carrier fluid (AC). If the fracking fluid (FF) comprises urea, the fracking fluid (FF) comprises generally 5 to 30% by weight, preferably 10 to 25% by weight, of urea, based in each case on the total weight of the fracking fluid (FF).

Optionally, the fracking fluid (FF) may comprise an oxidizing agent (O). Suitable oxidizing agents (O) are, for example, hydrogen peroxide or ammonium nitrate. The oxidizing agent (O) is preferably likewise dissolved in the aqueous carrier fluid (AC). A preferred oxidizing agent (O) is ammonium nitrate. Oxidizing agents (O) can be added to the fracking fluid (FF) in order to increase the amount of energy released in method step b). The oxidizing agent (O) may be present in the fracking fluid (FF) in amounts of 0 to 50% by weight, preferably in amounts of 1 to 10% by weight and more preferably in amounts of 1 to 5% by weight, based in each case on the total weight of the fracking fluid (FF).

At relatively low deposit temperatures (T_{D}), the fracking fluid (FF) may comprise alkali or acid. These accelerate the oxidation of the aluminum.

It is additionally possible to add thickeners to the fracking fluid (FF) in order to increase the viscosity of the fracking fluid (FF) and to prevent the sedimentation of the aluminum particles used and of any proppant (PP). In this case, the fracking fluid (FF) comprises generally 0.001 to 1% by weight of at least one thickener, based on the total weight of the fracking fluid (FF).

Examples of suitable thickeners include synthetic polymers, for example polyacrylamide or copolymers of acrylamide and other monomers, especially monomers having sulfo groups, and polymers of natural origin, for example glucosyl glucans, xanthan, diutans or glucan. Preference is given to glucan. The addition of gel breakers is unnecessary since, after the temperature is increased in method step b), the fracking fluid (FF) in the fracks (FR) loses its viscosity. In one embodiment, the fracking fluid does not comprise any thickener.

Because of the small particle size of the aluminum used and of any proppant (PP) used, and because of the turbulence in the well in the course of performance of method step a), the aluminum particles and any proppant (PP) used sediment only gradually, and so the addition of thickeners is not absolutely necessary. The turbulence which occurs in the course of injection of the fracking fluid (FF) in method step a), even without the use of thickeners, may be sufficient to keep the aluminum particles and any proppant (PP) suspended.

It is also possible to add at least one surface-active component (surfactant) to the fracking fluid (FF). In this case, the fracking fluid (FF) comprises preferably 0.1 to 5% by weight, more preferably 0.5 to 1% by weight, of at least one surfactant, based on the total weight of fracking fluid (FF).

The surface-active components used may be anionic, cationic and nonionic surfactants.

Commonly used nonionic surfactants are, for example, ethoxylated mono-, di- and trialkylphenols, ethoxylated fatty alcohols and polyalkylene oxides. In addition to the unmixed polyalkylene oxides, preferably C₂-C₄-alkylene oxides and phenyl-substituted C₂-C₄-alkylene oxides, especially polyethylene oxides, polypropylene oxides and poly(phenylethylene oxides), particularly block copolymers, especially polymers having polypropylene oxide and polyethylene oxide blocks or poly(phenylethylene oxide) and polyethylene oxide blocks, and also random copolymers of these alkylene oxides, are suitable. Such alkylene oxide block copolymers are known and are commercially available, for example, under the Tetronic and Pluronic names (BASF).

Typical anionic surfactants are, for example, alkali metal and ammonium salts of alkyl sulfates (alkyl radical: C₈-C₁₂), of sulfuric monoesters of ethoxylated alkanols (alkyl radical: C₁₂-C₁₈) and ethoxylated alkylphenols (alkyl radicals: C₄-C₁₂), and of alkylsulfonic acids (alkyl radical: C₁₂-C₁₈).

Suitable cationic surfactants are, for example, the following salts having C₆-C₁₈-alkyl, alkylaryl or heterocyclic radicals: primary, secondary, tertiary or quaternary ammonium salts, pyridinium salts, imidazolinium salts, oxazolinium salts, morpholinium salts, propylium salts, sulfonium salts and phosphonium salts. Examples include dodecylammonium acetate or the corresponding sulfate, disulfates or acetates of the various 2-(N,N,N-trimethylammonium)ethylparaffin esters, N-cetylpyridinium sulfate and N-laurylpyridinium salts, cetyltrimethylammonium bromide and sodium laurylsulfate.

The use of surface-active components in the fracking fluid (FF) lowers the surface tension of the fracking fluid (FF). In one embodiment, the free-flowing composition (FC) does not comprise any surfactants.

In a preferred embodiment, the fracking fluid (FF) comprises
1 to 65% by weight of proppant (PP),
1 to 3.52% by weight of aluminum,
0 to 50% by weight of oxidizing agent,
10 to 25% by weight of urea and
20 to 88% by weight of water,
   where the percentages by weight are each based on the total weight of the fracking fluid (FF). The sum of the percentages by weight adds up to 100% by weight.

In the above-described composition, portions of the water may be replaced by an organic solvent such as methanol, ethanol and/or glycerol.

The inventive fracking fluid (FF) is not a thermite composition. Thermite compositions are compositions which comprise a metal as the fuel component and an oxide of a metal other than the fuel component as the oxidizing agent, for example a mixture of iron oxide and aluminum.

Method step a)

The techniques for hydraulic fracking are known to those skilled in the art and are outlined briefly in the introductory part of the present description.

In method step a), the fracking fluid (FF) is injected into the well with a pressure greater than the minimum in-situ rock stress of the underground formation. As a result of the hydraulic action of the liquid pressure of the fracking fluid (FF), this forms fissure structures and cracks, also referred to as fracks (FR), in the area surrounding the well. The minimum in-situ rock stress of the underground formation is also referred to as minimum principal stress. This is understood to mean the pressure necessary to form fracks (FR) in the underground formation.

The pressure necessary for this purpose depends on the geological and geomechanical conditions in the underground formation. These conditions include, for example, the rock pressure/depth, deposit pressure, stratification and the rock strength of the underground formation. In practice, for the performance of method step a), the pressure is increased until the formation of fracks (FR) occurs. The pressures necessary for this purpose are typically in the range from 100 to 10 000 bar or 100 to 1000 bar, preferably in the range from 400 to 1000 bar, more preferably in the range from 600 to 1000 bar and especially preferably in the range from 700 to 1000 bar. At the same time, the pumping rates can rise up to 10 m³/min.

The fracks (FR) formed in method step a) are filled with the fracking fluid (FF). If the fracking fluid (FF) comprises a proppant (PP), it is introduced into the fracks (FR) together with the aluminum particles. The proppant (PP) prevents the fracks (FR) from closing again after any reduction in pressure.

If the fracking fluid (FF) comprises a mixture of n-aluminum and μ-aluminum, the μ-aluminum is introduced into the fracks (FR). The n-aluminum is introduced into the pores of the rock surrounding the fracks (FR).

Suitable apparatus for building up the pressures required is known to those skilled in the art. Typically, the section of the well which is to be hydraulically fracked in method step a) is isolated from the adjoining well section by means of a seal (packer). The fracking fluid (FF) is typically introduced through a work string into the region which is to be fracked. For buildup of the pressure required, typically several pumps are used simultaneously.

Method step b)

Method step b) involves waiting for a rest phase, in which an exothermic oxidation reaction between aluminum and water proceeds. The duration of the rest phase in method step b) is generally one hour to three days.

In method step b), the fracking fluid (FF) may be under a pressure higher than, equal to or lower than the pressure in method step a). Preferably, the fracking fluid (FF) during method step b) is kept under a pressure corresponding at least to the in-situ rock stress. This prevents the fracking fluid (FF) from flowing out of the fracks (FR) into the well. This ensures that the proppant (PP) remains in the fracks formed in method step a). However, this is not absolutely necessary. It is also possible that the fracking fluid (FF) in method step b) is under a pressure lower than the in-situ rock stress.

The present invention provides a method wherein the fracking fluid (FF) during method step b) is under a pressure at least equal to the in-situ rock stress.

The exothermic oxidation reaction of aluminum with water follows the reaction equation below

2 Al+3 H₂O=>Al₂O₃+3 H₂+heat

2 mol of aluminum and 3 mol of water thus give rise to 1 mol of aluminum oxide, 3 mol of hydrogen and heat.

The exothermic oxidation of aluminum with water releases 459.1 kJ of heat per mole of aluminum.

The evolution of heat takes place at the surface of the aluminum particles, i.e. at the interface between aluminum and water. As a result, primarily the aluminum particles and then the water in the fracking fluid (FF) are heated.

At temperatures of the fracking fluid (FF) below 65° C., the oxidation of aluminum with water (without additives) proceeds very slowly without any noticeable rise in the temperature of the fracking fluid (FF). When the temperature of the fracking fluid (FF) is above 65° C., in contrast, the oxidation of aluminum with water proceeds rapidly. At these temperatures, the oxidation of aluminum with water takes place spontaneously and continues without external energy supply. At temperatures above 65° C., no detonator is thus required to initiate the exothermic reaction.

As already described above, the fracking fluid (FF) comprises water and aluminum in a mass ratio M_{aq}:M_{Al} of >25, where M_{aq} indicates the mass of the water present in the fracking fluid (FF) in kg and M_{Al} the mass of the aluminum present in the fracking fluid (FF) in kg. Preferably, the mass ratio M_{aq}:M_{Al} is in the range from >25 to 200, more preferably in the range from >25 to 100.

At the above-described mass ratio M_{aq}:M_{Al}, i.e. when the proportion by mass of the water in the fracking fluid (FF) is 25 times greater than the proportion by mass of the aluminum in the fracking fluid (FF), it is reliably assured that the aluminum particles introduced into the fracks (FR) in method step a) will be fully oxidized.

As already described above, if at least some of the aluminum particles used are larger than the rock pores, the above-described aluminum concentration is sufficient. It is of course also possible to use higher aluminum concentrations. If at least some of the aluminum particles are larger than the rock pores, the aluminum particles accumulate in the fracks (FR) formed in method step a). The rock pores function here effectively as filters. The water present in the fracking fluid (FF) penetrates into the rock pores. The aluminum particles are retained at the boundary between frack (FR) and the surrounding rock.

As a result, the mass ratio M_{aq}: M_{Al} in the frack (FR) decreases. The mass ratio M_{aq}:M_{Al} in the frack (FR) is thus significantly lower after the performance of method step a) than the mass ratio of the fracking fluid (FF) originally used. In other words, this means that the concentration of aluminum in the fracks (FR) increases. This enables, in method step b), the attainment of temperatures within the frack (FR) which are sufficient to dry out the fracks (FR). The fracks (FR) are thus rehabilitated, as described above, effectively in method step b) itself.

The temperature rise simultaneously results in decomposition of chemical additives, for example thickeners, in the fracks (FR). This prevents the deposition of thickeners in the fracks (FR) and increases the permeability of the proppant layer in the fracks (FR). The aluminum concentration in the fracks (FR) is thus much higher after performance of method step a) than the aluminum concentration of the fracking fluid (FF) used, which has been produced above ground.

If some of the aluminum particles, preferably the n-aluminum particles, are smaller than the rock pores, the n-aluminum particles penetrate into the rock pores together with the water present in the fracking fluid (FF). The aluminum concentration in the rock pores is typically smaller than the aluminum concentration in the fracks (FR), and is additionally generally smaller than the aluminum concentration of the fracking fluid (FF) produced above ground.

The rise in aluminum concentration in the fracks (FR) thus has a positive effect. The rise in concentration leads to a rise in the amount of heat released in the fracks (FR). In addition, the aluminum particles collect at the walls of the fracks (FR) and simultaneously decompose thickeners used.

Laboratory studies have shown that the spontaneous reaction of the aluminum with water, given the excess of water, proceeds very slowly. This relates to the mass ratios in the fracks (FR), which are M_{aq}:M_{Al}>90, where M_{aq} indicates the mass of the water present in the fracking fluid (FF) in kg and M_{Al} the mass of the aluminum present in the fracking fluid (FF) in kg. According to laboratory studies, optimal mass ratios in the fracks (FR) are as follows: 10>M_{aq}:M_{Al}<30. Taking into account the accumulation in the fracks (FR), the fracking fluid (FF) can be produced above ground with mass ratios of 20>M_{aq}:Mₐₗ<300.

Laboratory studies have shown that, in the weakly basic solutions having a pH of 7.7 to 8, the spontaneous reaction between aluminum and water sets in without water heating. In a further embodiment, therefore, substances which release ammonia when heated are added to the fracking fluid (FF). Suitable substances which release ammonia when heated are, for example, urea or ammonium salts.

The decomposition of the urea underground releases ammonia, which dissolves in the water in the fracking fluid (FF). This increases the pH of the fracking fluid (FF), and the oxidation reaction between aluminum and water sets in spontaneously. The increase in the pH generally commences after formation of the fracks (FR) in method step a). After formation of the fracks (FR), the fracking fluid (FF) heats up, as a result of which the decomposition of the urea sets in and ammonia is released.

At the above-described mass ratios M_{aq}:M_{Al}, it is reliably assured that the aluminum particles introduced into the fracks (FR) in method step a) are fully oxidized.

The exothermic oxidation reaction of aluminum with water forms, as oxidation products, aluminum hydroxides and aluminum oxides, which are insoluble in water. Owing to the low particle size of the aluminum used in the oxidation reaction, the oxidation products (aluminum hydroxide and aluminum oxide) have a high degree of dispersion. The aluminum hydroxides and aluminum oxide formed in the exothermic oxidation reaction are additionally porous. The oxidation products thus do not block the fracks (FR) formed in method step a). The porous oxidation products instead act like a proppant (PP), particularly for gas deposits, and can thus additionally contribute to improving hydrodynamic communication.

In the course of the exothermic oxidation reaction of aluminum with water, temperatures at which the water present in the fracking fluid (FF) (and any further solvents present) are vaporized or decomposed are attained. In the course of the oxidation of aluminum with water, water is additionally consumed. This can result in formation of additional microcracks through evolution of heat and steam formation.

The exothermic oxidation reaction which proceeds in method step b) results in very substantial removal of all components of the fracking fluid (FF), except for the proppant (PP) and the oxidation products of aluminum, from the fracks (FR). The fracks (FR) formed in method step a) thus rehabilitate themselves automatically in method step b).

Further components which may be present in the fracking fluid (FF), for example thickeners or further organic solvents, are likewise vaporized or decomposed in method step b). The rehabilitation of the fracks (FR) is additionally promoted by the gas and vapor pressure which arises, and this forces all components of the fracking fluid (FF), except for the proppant (PP) and the oxidation products of aluminum, from the tip of the frack (FR) in the well direction.

In the processes described in the prior art for rehabilitation of fracks (FR), in the rehabilitation step, the proppants used are at least partly flushed out of the fracks (FR) again. The method according to the invention very substantially prevents flushing of the proppant (PP) back out of the fracks (FR).

The heat which arises in the course of the oxidation of aluminum with water, in conjunction with the hydrogen formed, can result in widening of the pores in the rock strata adjoining the fracks (FR) and in an increase in the porosity of these rock strata. This is accomplished by the gas pressure which arises (effect of steam or gas pressure) in conjunction with the heat which arises (thermal shock).

As a result of this, the pores present in the adjoining rock strata can be widened. New pores may also be formed. As explained above, this is promoted by the evolution of hydrogen. The oxidation of one gram of aluminum with water evolves approx. 1.2 liters of hydrogen.

The above-described widening or new formation of pores in the rock strata adjoining the fracks (FR) is achieved especially when the fracking fluid (FF) comprises a mixture of n-aluminum and μ-aluminum.

If the fracking fluid (FF) comprises urea, the urea is converted with the water present in the fracking fluid (FF) by hydrolysis to ammonia and carbon dioxide according to the following equation:

H₂N—CO—NH₂+H₂O→2NH₃+CO₂

One mole of urea and one mole of water form two moles of ammonia and one mole of carbon dioxide. The hydrolysis of urea with water under the action of heat is also referred to as thermohydrolysis. From a temperature greater than 65° C., the hydrolysis of urea and water proceeds with sufficient rapidity to fully hydrolyze the urea and the water to carbon dioxide and ammonia within economically viable periods of time. The rate of hydrolysis of urea rises with increasing temperature. The use of urea allows an increase in the gas rate in method step b) and hence an increase in the gas pressure in the fracks (FR). This promotes the rehabilitation of the fracks (FR) and the extension or new formation of pores in the rock adjoining the fracks (FR).

The same effect is also achieved in the case of addition of the ammonium salts (e.g. ammonium carbonate) to the fracking fluids.

As explained above, the exothermic oxidation reaction between aluminum and water proceeds spontaneously at temperatures above 65° C., without any need for further supply of heat thereto. At these temperatures (>65° C.), the hydrolysis of urea also sets in. These two reactions, i.e. the oxidation reaction of aluminum with water and the hydrolysis of urea with water, enhance one another. The hydrolysis of urea forms, as explained above, carbon dioxide and ammonia. In the course of this, the ammonia dissolves at first in the water present in the fracking fluid (FF). This increases the pH of the fracking fluid (FF). The rise in the pH accelerates the dissolution of the passivation layer present on the aluminum particles and accelerates the exothermic oxidation reaction. The exothermic reaction of the aluminum with water releases heat, which itself in turn accelerates the hydrolysis of the urea with water.

At deposit temperatures T_{D} of greater than 65° C., no detonator is thus required to initiate the exothermic reaction. In one embodiment of the method according to the invention, no detonator is used to initiate the exothermic oxidation reaction in method step b).

The present invention thus also provides a method in which the underground formation is an underground hydrocarbon deposit. The present invention further provides a method in which the underground formation is a natural gas deposit having a deposit permeability of less than 10 millidarcies.

The present invention additionally provides a process for hydraulic fracking of an underground hydrocarbon deposit having a deposit temperature T_{D} of >65° C. The deposit temperature T_{D} is preferably in the range from >65 to 200° C., preferably in the range from 70 to 150° C., more preferably in the range from 80 to 140° C.

In order to reliably prevent onset of the exothermic oxidation reaction between aluminum and water and onset of the hydrolysis of any urea present outside the underground formation, the fracking fluid (FF) in method step a) is preferably injected into the underground formation (the underground hydrocarbon deposit) at a temperature of the fracking fluid T_{FF} less than the deposit temperature T_{D}. In method step a), the condition T_{FF}<T_{D} thus applies. The fracking fluid (FF) in method step a) is thus preferably used at temperatures ≦65° C. The temperature of the fracking fluid T_{FF} in method step a) is preferably in the range from −5 to 60° C., preferably in the range from 0 to 60° C., and more preferably in the range from +10 to 60° C.

This reliably prevents premature onset of the exothermic oxidation reaction between aluminum and water, and the hydrolysis reaction between water and urea.

After injection of the fracking fluid (FF) in method step a) and formation of the fracks (FR), the fracking fluid (FF) is heated gradually under the action of the thermal conditions of the underground formation (of the underground hydrocarbon deposit). This heating takes place in method step b) of the method according to the invention. During the rest phase, the fracking fluid (FF) attains temperatures >65° C., as a result of which the exothermic oxidation reaction between aluminum and water, and any hydrolysis reaction between water and urea, sets in.

The present invention thus also provides a method for hydraulic fracking of an underground hydrocarbon deposit (of an underground formation), in which the fracking fluid (FF) is introduced in method step a) at a temperature T_{FF} less than the deposit temperature T_{D} of the underground hydrocarbon deposit (of the underground formation).

The present invention is illustrated in detail by the working examples which follow, but they do not restrict the invention thereto.

### Working Examples

The development of a low-lying tight gas deposit is described hereinafter. The tight gas deposit has the following parameters:
depth in the range from 3800 to 4100 m (TVDss; true vertical depth minus elevation above sea level)
initial pressure 620 bar
deposit temperature 120° C.
relative gas density 0.61
porosity about 10 to 14%
permeability about 0.02 to 0.20 mD (millidarcies)
initial water saturation about 30%
thickness about 70 to 90 m

To develop the tight gas deposit, a fracking fluid with the following composition is produced (figures per m³ of fracking fluid (FF)):
200 kg of proppant (PP)
10 kg of a thickener
120 kg of urea
60 kg of aluminum powder
610 kg of water

The fracking fluid (FF) is subsequently injected into the deposit at a pressure of about 700 to 800 bar (method step a)), which forms fracks (FR). These fracks (FR) have widths in the range from 2 to 4 mm. The fracking fluid (FF) heats up to a temperature exceeding 100° C. within a period of 1 to 2 hours after commencement of the introduction. This temperature rise results in commencement of the spontaneous decomposition of the urea and the rise in the pH of the fracking fluid (FF). At the same time, the oxidation reaction between water and the aluminum powder present in the fracking fluid (FF) commences, and the oxidation reaction is stimulated even further by the ammonia released in the course of decomposition of urea. Some of the water present in the fracking fluid (FF) is consumed by the hydrolysis of the urea (about 20% of the water present in the fracking fluid (FF)).

The rest of the water present in the fracking fluid (FF) is consumed by the oxidation reaction of the aluminum. A further portion of the water is vaporized as a result of the rise in temperature. As a result of the abrupt rise in temperature in the fracks (FR), the thickener used is fully decomposed and the steam formed penetrates into the deposit and prevents the swelling of the clay particles/clay rocks in the deposit. The rest of the fracking fluid can subsequently be removed from the well by known rehabilitation measures. After completion of method step b), followed by the removal of the fracking fluid (FF) from the well, the production of natural gas is restarted by known techniques. The gas production rate is increased by 20 to 100% through the performance of the method according to the invention, compared to the initial production rate (production rate before performance of the method according to the invention). A crucial factor to which this is attributable is the fact that the method according to the invention prevents the watering-out of the deposit, since the inventive fracking fluid (FF) effectively rehabilitates itself.

Mathematical simulation calculations and laboratory studies have shown that the fracks (FR) have the following features:
frack (FR) half-length about 70 m
frack (FR) height about 50 m
frack (FR) conductivity about 1000 mD
average frack (FR) width about 2 to 4 mm
proppant (Proppant CarboProp 20/40) about 50 to 110 t

During the performance of the fracking method according to the invention, 400 to 500 m³ of fracking fluid (FF) are used.

1. A method for hydraulic fracking of an underground formation into which at least one well has been sunk, comprising the method steps of:
(a) introducing a fracking fluid (FF) through the at least one well into the underground formation at a pressure greater than a minimum in-situ rock stress for formation of fracks (FR) in the underground formation,
the fracking fluid (FF) comprising water and aluminum, and
(b) waiting for a rest phase in which an exothermic oxidation reaction between aluminum and the water from the fracking fluid (FF) takes place.

2. The method according to claim 1, wherein the fracking fluid (FF) additionally comprises a proppant (PP).

3. The method according to claim 1, wherein the aluminum is suspended in particulate form in the fracking fluid (FF), the particle size of the aluminum particles being in the range from 20 nm to 1000 μm.

4. The method according to claim 1, wherein the fracking fluid (FF) comprises a mixture of aluminum particles having a particle size in the range from 50 to less than 1000 nm (n-aluminum) and aluminum particles having a particle size in the range from 1 to less than 1000 μm (μ-aluminum).

5. The method according to claim 1, wherein the fracking fluid (FF) comprises a mixture of n-aluminum and μ-aluminum, the ratio of n-aluminum to μ-aluminum in the fracking fluid (FF) being in the range from 1:10 to 10:1.

6. The method according to claim 3, wherein at least some of the aluminum particles accumulate in the fracks (FR) formed in method step (a).

7. The method according to claim 1, wherein the underground formation has a temperature T_{D} and the fracking fluid (FF) is introduced in method step (a) at a temperature T_{FF} lower than T_{D}.

8. The method according to claim 1, wherein the underground formation has a temperature T_{D} in the range from greater than 65° C. to 200° C.

9. The method according to claim 1, wherein the fracking fluid (FF) is introduced in method step (a) at a temperature T_{FF} in the range from −5° C. to 60° C.

10. The method according to claim 1, wherein the fracking fluid (FF) during method step (b) is under a pressure at least equal to the minimum in-situ rock stress.

11. The method according to claim 1, wherein the fracking fluid (FF) comprises 5 to 30% by weight of urea or ammonium salts, based on the total weight of the fracking fluid (FF).

12. The method according to claim 1, wherein the fracking fluid (FF) comprises
1 to 65% by weight of proppant (PP),
1 to 3.52% by weight of aluminum,
0 to 50% by weight of oxidizing agent,
10 to 25% by weight of urea and
20 to 88% by weight of water.

13. The method according to claim 1, wherein the fracking fluid (FF) is introduced in method step (a) at pressures in the range from 100 to 1000 bar.

14. The method according to claim 1, wherein the duration of the rest phase is one hour to three days.

15. The method according to claim 1, wherein the underground formation is an underground hydrocarbon deposit.
